(19) United States
(12) Patent Application Publication
(10) Pub. No.: US 2026/0258680 A1
(43) Pub. Date: Sep. 3, 2026

(54) VEHICLE DOOR HANDLE SYSTEM

(71) Applicant: MINEBEA MITSUMI Inc., Nagano-ken (JP)

(72) Inventors: Thomas PEYNOT, Pianezza (IT); Sachin SHARMA, Pianezza (IT); Alexandre PIERI, Pianezza (IT); Manu SHARMA, Pianezza (IT); Piyush BHALLA, Pianezza (IT)

(73) Assignee: MINEBEA MITSUMI Inc., Nagano-ken (JP)

(21) Appl. No.: 19/549,943

(22) Filed: Feb. 25, 2026

(30) Foreign Application Priority Data
Feb. 28, 2025 (EP) 251609681

(51) Int. Cl. E05B 85/10; E05B 85/18

(52) U.S. Cl. CPC E05B 85/107; E05B 85/103; E05B 85/18

(57) ABSTRACT

A vehicle door handle system includes a wing handle movable between a stowed position and a deployed position. In the stowed position, an outer surface of the wing handle is configured to be flush with an outer surface of an adjacent window lower belt, and in the deployed position, the wing handle is configured to protrude outwardly with respect to the outer surface of the window lower belt. The vehicle door handle system further includes an actuator configured to move the wing handle between the stowed position and the deployed position. The movement of the wing handle between the stowed position and the deployed position includes a translation from and/or to the stowed position.

### CROSS-REFERENCE TO RELATED APPLICATIONS

This application claims priority to and the benefit of EP 25160968.1 filed on February 28, 2025. The disclosure of the above application is incorporated herein by reference.

### FIELD

The present disclosure relates to vehicles and, more particularly, to a vehicle door handle system.

### BACKGROUND

The statements in this section merely provide background information related to the present disclosure and may not constitute prior art.

Some vehicle door handles are known as wing handles. Wing handles have a generally flat design and an elongated shape. Wing handles are arranged aligned with a window lower belt of the vehicle door. A known wing handle is fixedly mounted to the respective door panel via a long side of the wing handle while having at least a free longitudinal end. The known wing handle operates upon manual operation through a slight deformation of the wing handle.

The known wing handle protrudes outwardly, and generates air flow turbulences that may reduce vehicle autonomy, by increasing fuel consumption or draining the battery faster, and may increase aerodynamic noise, which is especially relevant for electrical vehicles.

Being in constant protrusion with respect to the vehicle door, the known wing handle creates a design disruption, which may be considered unsightly.

In addition, vehicle doors generally have a tapered profile from bottom to top, whereby room may be too scarce at a higher level within the vehicle door panel to incorporate the operating mechanism of a wing handle.

Thus, there is a need for providing a vehicle door handle system that would solve the aforementioned problems of existing wing handles, i.e., solve altogether the vehicle autonomy reduction and reduce noise generation thereof, and provide for sleek vehicle design possibilities, while being adaptable to a broad number of implementations and vehicle designs.

### SUMMARY

This section provides a general summary of the disclosure and is not a comprehensive disclosure of its full scope or all of its features.

The present disclosure is related to a vehicle door handle system, comprising a wing handle, wherein the wing handle is movable between a stowed position and a deployed position, wherein:

in the stowed position, an outer surface of the wing handle is configured to be flush with an outer surface of an adjacent window lower belt;

in the deployed position, the wing handle is configured to be protruding outwardly with respect to said outer surface of the window lower belt;

wherein the vehicle door handle system comprises an actuator configured to move the wing handle between the stowed position and the deployed position,

wherein, the movement of the wing handle between the stowed position and the deployed position comprises a translation, for example from and/or to the stowed position.

Providing a translation between the stowed position and the deployed position of the wing handle allows for the vehicle door handle system to be mounted at a lower position within the vehicle door, i.e., in an area of greater inner volume of the vehicle door, while providing the wing handle readily accessible and operable by a vehicle user in the deployed position. As a consequence, the vehicle door handle system may be mounted in a broader range of eligible positions upon designing the vehicle.

Further, being flush in the stowed position, the wing handle generates less aerodynamic noise, and reduces the vehicle energy consumption when the vehicle is in service, improving the user comfort in using the vehicle. Such a configuration of the wing handle also contributes to the vehicle sleek design and improves the general aesthetic and visual impression of the vehicle.

Considered either alone or in any technically possible combination, the vehicle door handle system can comprise the following features.

The movement of the wing handle between the stowed position and the deployed position comprises a rotation, for example in which the wing handle is pivoted outwardly towards the deployed position and/or inwardly towards the stowed position;

The movement of the wing handle between the stowed position and the deployed position comprises the translation of the wing handle, followed or preceded by the rotation of the wing handle;

The movement of the wing handle between the stowed position and the deployed position comprises a deployment of the wing handle from the stowed position to the deployed position, the deployment comprising the translation of the wing handle followed by the rotation of the wing handle;

The movement of the wing handle between the stowed position and the deployed position comprises a retraction of the wing handle from the deployed position to the stowed position, the retraction comprising the rotation of the wing handle followed by the translation of the wing handle;

The vehicle door handle system comprises a swiveling member, for example wherein the wing handle is integrally mounted on the swiveling member, wherein, the actuator is configured to cause the swiveling member to translate so as to cause the translation of the wing handle, for example from and/or to the stowed position, and/or, wherein, the actuator is configured to cause the swiveling member to pivot so as to cause the rotation of the wing handle, for example outwardly towards the deployed position and/or inwardly towards the stowed position;

The vehicle door handle system comprises a bracket, for example wherein the bracket is configured to be fixedly mounted in position with respect to the window lower belt, wherein the swiveling member comprises at least one pivot member, the pivot member defining a first axis, wherein the swiveling member is mounted to the bracket via said at least one pivot member, and wherein the swiveling member is configured to move in rotation with respect to the bracket around the first axis when the actuator causes the swiveling member to pivot so as to cause the rotation of the wing handle, for example outwardly to the deployed position;

The swiveling member further comprises at least one first guiding member, and the bracket comprises at least one second guiding member, wherein the at least one first guiding member and the at least one second guiding member are configured to slidingly cooperate with each other in guiding the swiveling member when the actuator causes the swiveling member to pivot;

The first guiding member is a finger, wherein the at least one finger extends along a second axis parallel to the first axis along which the at least one pivot member is extending, wherein the second guiding member is a curved guiding rib, wherein the finger and the curved guiding rib are configured so that the finger is traveling along the curved guiding rib when the swiveling member is moving in rotation around the at least one pivot member over the rotation;

The bracket has at least one oblong opening, wherein the at least one pivot member is both slidingly and pivotingly mounted in the at least one oblong opening, wherein, over the translation, the swiveling member is moved in translation with respect to the bracket by the at least one pivot member translating in the oblong opening until a first end of the oblong opening, whereby the first end of the oblong opening forms an abutment position for the at least one pivot member,

wherein, over the rotation, the swiveling member is movable in rotation with respect to the bracket around the pivot member in the abutment position of the pivot member at the first end of the oblong opening;

The bracket comprises at least one straight guiding rib, wherein, over the translation, the at least one finger is moved in translation with respect to the at least one straight guiding rib, for example concurrently to the at least one pivot member being moved in translation in the oblong opening until the first end of the oblong opening, for example the at least one curved guiding rib extending from the at least one straight guiding rib;

The vehicle door handle system comprises a link arm slidingly mounted in the bracket, wherein the actuator is configured to cause the link arm to move in translation with respect to the bracket so as to interact with the swiveling member, for example so as to exert a pushing force to the swiveling member so as to move to the wing handle towards the deployed position.

The present disclosure may further relate to a vehicle door comprising such a vehicle door handle system, wherein the vehicle door comprises the window lower belt, wherein:

in the stowed position, the outer surface of the wing handle is configured to be flush with the outer surface of the window lower belt;

in the deployed position, the wing handle is configured to be protruding outwardly with respect to the outer surface of the window lower belt.

The present disclosure may further relate to a vehicle comprising one or more such vehicle door(s), and/or one or more of the aforementioned vehicle door handle system(s), wherein the vehicle comprises the window lower belt, wherein:

in the stowed position, the outer surface of the wing handle is configured to be flush with the outer surface of the window lower belt;

in the deployed position, the wing handle is configured to be protruding outwardly with respect to the outer surface of the window lower belt.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

The foregoing and other purposes, features, aspects and advantages of the invention will become apparent from the following detailed description of embodiments, given by way of illustration and not limitation, with reference to the accompanying drawings, in which the same reference refer to similar elements or to elements having similar functions, and in which:

FIG. 1 shows a part of a vehicle side comprising a vehicle door handle system, according to an embodiment;

FIG. 2 is an exploded view of the vehicle door handle system of FIG. 1, showing a wing handle, a swiveling member, a link arm, a bracket, and an actuator of the vehicle door handle system, according to an embodiment;

FIGS. 3A and 3B are perspective views of the vehicle door handle system of FIGS. 1 and 2 in an assembled state and in a stowed position, according to an embodiment;

FIGS. 4A, 4B and 4C are side views of the vehicle door handle system of FIGS. 1 and 2, respectively in a stowed position, in an intermediate position, and in a deployed position, according to an embodiment;

FIG. 5 is a detailed side view of the vehicle door handle system of FIGS. 1 and 2 showing the relationship between the wing handle, the swiveling member and a strain gauge of the vehicle door handle system, according to an embodiment;

FIG. 6 shows an exemplary embodiment of the wing handle of FIGS. 1 and 2, according to an embodiment;

FIGS. 7 A and 7 B are respectively a section side view of the swiveling member of FIG. 2, and a perspective view of the swiveling member of FIG. 7a, according to an embodiment;

FIG. 8 is a perspective view of the main body of the bracket of FIG. 2, according to an embodiment;

FIG. 9 is a perspective view showing the inside of the cover of the bracket of FIG. 8, according to an embodiment.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

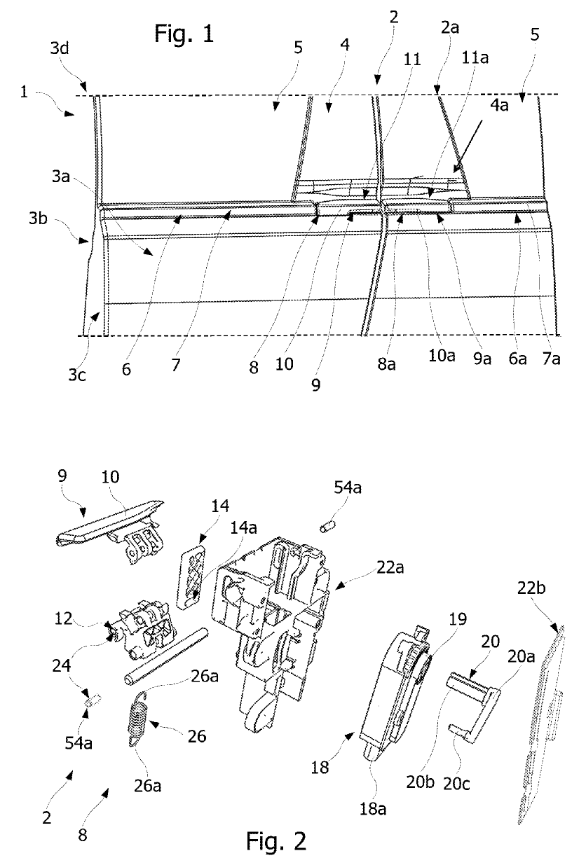

With reference to FIG. 1, a vehicle 1, a vehicle door 2 and a door handle system 8 are described. The vehicle 1 shown on FIG. 1 may comprise the vehicle door 2. The vehicle door 2 may comprise the door panel 4 (partially illustrated in FIG. 1), a window 5, and/or a window lower belt 6. The door panel 4 may extend between an outer body plate 3a and an inner body plate 3b. As visible on FIG. 1, the profile of the vehicle door 2 may be tapered from the bottom 3c to the top 3d thereof.

The vehicle 1 and/or the vehicle door 2 may comprise the door handle system 8, described in more details with reference to FIG. 2. The door handle system 8 is preferably partly housed in the door panel 4.

The door handle system 8 comprises in particular a handle, for example a wing handle 9. Here “wing handle” designates a grip element located in the area of the B-pilar and which allows the user to pull the door. The wing handle 9 may for example have a generally flat design and an elongated shape. Herein, the wing handle 9 is movable between a stowed position and a deployed position.

In the stowed position of the wing handle 9, an outer surface 10 of the wing handle 9 is configured to be flush with an outer surface 7 of the adjacent window lower belt 6. In the deployed position, the wing handle 9 is configured to be protruding outwardly with respect to said outer surface 7 of the window lower belt 6.

The door handle system 8 comprises an actuator 18 configured to move the wing handle 9 between the stowed position and the deployed position, for example over a movement of the wing handle (9) between the stowed position and the deployed position. The movement of the wing handle 9 between the stowed position and the deployed position comprises a translation. For example, the translation may be towards the deployed position and/or inwardly towards the stowed position, for example from and/or to the stowed position.

Such a translation movement of the wing handle 9 allows for the wing handle 9 to move in a bottom 3c to top 3d direction with respect to the vehicle door 2. This aspect provides greater implementation room within the vehicle door 2.

According to an embodiment, the vehicle door 2 of the vehicle 1 has a recess 11 (FIG. 1). The recess 11 may be formed in the exterior outline of the door panel 4. In the stowed position of the wing handle 9, the wing handle 9 is housed within recess 11.

The wing handle 9, individually illustrated in FIG. 6, may comprise a grabbing portion 40, a connection wall 41, and connection flanges 42. In the illustrated embodiment, the grabbing portion 40 is bent along a substantially longitudinal direction.

The grabbing portion 40 may comprise the outer surface 10. The outer surface 10 is provided to be an external surface of the vehicle, facing outwardly. The outer surface 10 may thus be visible to a vehicle user, and contribute to the general design of the vehicle. The outer surface 10 may be flat, or may have a bent shape. In the illustrated embodiment, the outer surface 10 is in particular bent around a substantially longitudinal direction. Other configurations of the grabbing portion 40 and/or shapes of the outer surface 10 are however possible.

The connection wall 41 extends from a longitudinal edge 40a of the grabbing portion 40. The connection flanges 42 may herein each comprise a connection leg 43 and an eyelet 44. In the illustrated embodiment, the wing handle 9 comprises three connection flanges 42. The number of connection flanges 42 may differ from three, and be for example one, or two, or more than three. Herein, two connection flanges 42 additionally comprise a stop 45 at the respective distal end thereof.

The connection flanges 42, in particular the connection legs 43, extend from an edge 41a of the connection wall 41 opposed to that connected to the grabbing portion 40. The connection flanges 42 are used to connect with the swiveling member using a securing element such as a screw or axis or else. The eyelets 44 are formed on a respective connection leg 43. Each eyelet 44 is provided with a cylindrical opening 46. The openings 46 are oriented along an axis X3’.

The actuator 18 may comprise a lever 20 and an element such as a socket 19 to insure a torque transmission between the actuator and the lever (FIG. 2). The lever 20 may comprise an arm 20a, a ribbed cylindrical section 20b, and a finger 20c. The arm 20a is preferably substantially flat. The ribbed cylindrical section 20b and the finger 20c preferably both extend from a same side of the arm 20a. The socket 19 may have a ribbed cylindrical inner wall. This allows for the ribbed cylindrical section 20b to be inserted and retained in a form-fitting manner into the socket 19. The socket 19 can be driven in rotation and cause the lever 20 inserted therein to rotate. The actuator 18 may be electrically or electronically driven. For example, the actuator 18 may include a brushless motor (not shown).

In the door handle system 8, the movement of the wing handle 9 between the stowed position and the deployed position comprises a rotation. The wing handle 9 may be, for example, pivoted outwardly towards and/or inwardly from the deployed position. Such a movement between the stowed position and the deployed position having both a rotation and a translation further improves the vehicle design possibilities.

The movement of the wing handle 9 between the stowed position and the deployed position comprises the translation of the wing handle 9, followed or preceded by the rotation of the wing handle 9.

In the illustrated embodiment, the movement of the wing handle 9 between the stowed position and the deployed position comprises a deployment of the wing handle 9 from the stowed position to the deployed position, the deployment comprising the translation of the wing handle 9 followed by the rotation of the wing handle 9.

The door handle system 8 may comprise a swiveling member 12. The wing handle 9 may for example be integrally mounted on the swiveling member 12. The actuator 18 may be configured to cause the swiveling member 12 to translate so as to cause the translation of the wing handle 9, for example from and/or to the stowed position. The actuator 18 may be configured to cause the swiveling member 12 to pivot so as to cause the rotation of the wing handle 9, for example outwardly towards the deployed position and/or inwardly towards the stowed position.

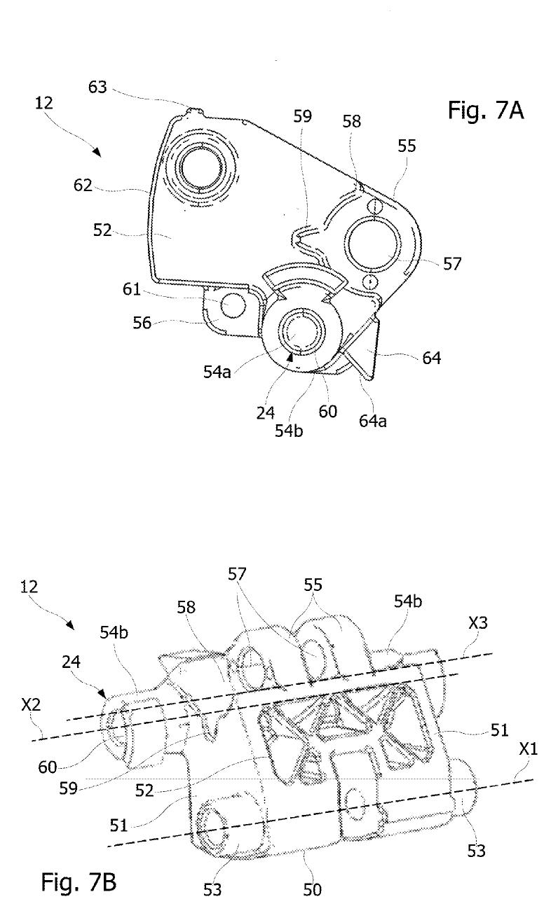

The swiveling member 12, individually illustrated in FIGS. 7A and 7B, has a body 50 defined between two opposing faces 51. According to an embodiment, the faces 51 are parallel to each other. A hollow lattice structure 52 may be provided between the two faces 51, and stretches from one face 51 to the other face 51. This hollow lattice structure 52 imparts the swiveling member 12 a compromise between rigidity upon operation thereof, weight limitation, and sufficient elasticity for the swiveling member 12 to deform in order to contact a strain gauge 30 of the door handle system 8, as explained later.

The swiveling member 12 may comprise at least one pivot member 24. The pivot member 24 may define an axis X2, for example a first axis X2. The at least one pivot member 24 may be at least partially cylindrical, for example with a circular cross-section.

The at least one pivot member 24 may comprise at least one finger 54b. The finger 54b may have an internal housing 60 (FIGS. 7A and 7B), accommodating a separate pin 54a (FIG. 2), whereby the pin 54a extends along axis X2. Alternatively, although not illustrated, the at least one pivot member 24 may be formed as an integral part of the swiveling member 12.

The at least one pivot member 24 may comprise for example a pair of pivot members 24. The pivot members 24 may then protrude from a respective face 51 and extend away from each other. Preferably, both pivot members 24 extend along axis X2.

The door handle system 8 may additionally comprise a bracket 16. For example, the bracket 16 may be configured to be fixedly mounted in position with respect to the window lower belt 6. The swiveling member 12 may be mounted to the bracket 16 via said at least one pivot member 24. The swiveling member 12 may be configured to move in rotation with respect to the bracket 16 around axis X2 when the actuator 18 causes the swiveling member 12 to pivot so as to cause the rotation of the wing handle 9, for example outwardly to the deployed position.

Providing the bracket 16 allows the swiveling member 12 to be precisely mounted in position with respect to the vehicle 1, i.e., to the vehicle door 2, prior to the wing handle 9 being mounted onto the swiveling member 12.

The swiveling member 12 may further comprise at least one first guiding member 53 or 93, and the bracket 16 may comprise at least one second guiding member 93 or 53, wherein the at least one first guiding member 53 or 93 and the at least one second guiding member 93 or 53 may be configured to slidingly cooperate with each other in guiding the swiveling member 12 when the actuator 18 causes the swiveling member 12 to pivot. The first and/or second guiding members 53, 93 may be formed by one or two axes.

For example, the at least one first guiding member 53 or 93 may be a finger 53. The at least one finger 53 may extend along an axis X1, for example a second axis X1, parallel to axis X2 along which the at least one pivot member 24 is extending. The second guiding member 93 or 53 may be a curved guiding rib 93. The finger 53 and the curved guiding rib 93 may be configured so that the finger 53 is traveling along the curved guiding rib 93 when the swiveling member 12 is moving in rotation around the at least one pivot member 24 over the rotation.

The first and second guiding members 53 and 93 ensure the swiveling member 12 follows a precise trajectory upon moving the door handle between the stowed position and the deployed position.

The at least one first guiding member 53 may preferably be a pair of fingers 53. The fingers 53 may be protruding from a respective face 51 and extend away from each other. The fingers 53 may be both oriented along axis X1.

In the shown embodiment, the swiveling member 12 is also provided with a plurality of flanges 55 (FIG. 7B), herein two. Flanges 55 are preferably flat protrusions; generally extending parallel to each other. Herein, each of the flanges 55 is provided with a cylindrical opening 57. The openings 57 are oriented along an axis X3. The number of flanges 55 may differ, and be for example one or three, or more.

In the illustrated embodiment, the axis X1 and the axis X2 described above are parallel to each other. According to an example, axis X3 may also be parallel to axes X1 and X2, as illustrated in FIG. 7B.

The swiveling member 12 may further comprise an eyelet 56 (FIG. 7A). The eyelet 56 may have an opening 61. The opening 61 provides an attachment point for an elastic member 26 such as a spring. The eyelet 56 is provided on the swiveling member 12 between a contact surface 62, described later, and the pivot members 24. In other words, the eyelet 56 and the contact surface 62 are provided on a same side of the pivot members 24.

Recesses 58 are formed in the body 50 of the swiveling member 12 on either sides of the flanges 55. Further recesses 59 formed in the body 50 are formed through the bottom surface of recesses 58. The recesses 58, 59 are provided to put in the right place before assembly and to avoid any rotation of the handle during assembly.

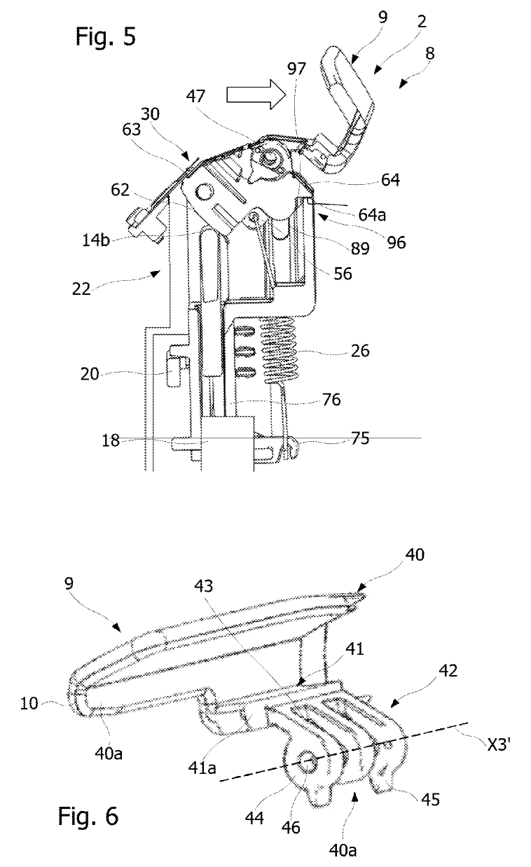

The swiveling member 12 further may further have a contact surface 62, a contact surface 63 and/or an abutment section 64 having an abutment surface 64a (FIGS. 5 and 7A). The contact surface 62 is intended to be in contact with the contact section 14b. The contact surface 62 is therefore preferably convex. The inner side of the curvature is facing flanges 55 and fingers 54. The contact surface 63 is herein flat, in a non-limiting manner. The contact surface 63 is intended to get in contact with the strain gauge 30 shown in FIG. 5. The wing handle 9 and the swiveling member 12 are intended to be assembled with each other within the door handle system 8. In the assembled state, the connection flanges 42 of the wing handle 9 may cooperate, for example interlock, with flanges 55 of the swiveling member 12 in such a way that the recesses 58 accommodate the eyelets 44.

According to an example, the recesses 59 accommodate the stops 45 in a snug-fit relationship. The openings 46 of the eyelets 44 and the openings 57 of the flanges 55 may then be aligned with each other. An assembling member 47, e.g. a bolt, visible on FIG. 5, then connects the wing handle 9 to the swiveling member 12. The wing handle 9 may thus be fixedly attached to the swiveling member 12. Once assembled, the wing handle 9 and the swiveling member 12 are integral with each other, and may be made to translate and/or rotate together. Preferably, in this assembled state, axis X3’ overlaps with axis X3.

The bracket 16 may have at least one oblong opening 89. The at least one pivot member 24 may be both slidingly and pivotingly mounted in the at least one oblong opening 89. Over the translation, the swiveling member 12 may be moved in translation with respect to the bracket 16 by the at least one pivot member 24 translating in the oblong opening 89 until a first end 89a of the oblong opening 89, whereby the first end 89a of the oblong opening 89 forms an abutment position for the at least one pivot member 24. Over the rotation, the swiveling member 12 may be movable in rotation with respect to the bracket 16 around the pivot member 24 in the abutment position of the pivot member 24 at the first end 89a of the oblong opening 89.

The bracket 16 may comprise at least one straight guiding rib 92, wherein, over the translation, the at least one finger 53 may be moved in translation with respect to the at least one straight guiding rib 92, for example concurrently to the at least one pivot member 24 being moved in translation in the oblong opening 89 until the first end 89a of the oblong opening 89, for example the at least one curved guiding rib 93 extending from the at least one straight guiding rib 92.

The door handle system 8 may comprise a link arm 14 slidingly mounted in the bracket 16, wherein the actuator 18 is configured to cause the link arm 14 to move in translation with respect to the bracket 16 so as to interact with the swiveling member 12, for example so as to exert a pushing force to the swiveling member 12 so as to move to the wing handle 9 towards the deployed position.

The link arm 14 may be an elongated part (FIG. 2). In the represented embodiment, the link arm 14 is a flat part. The link arm 14 may have a rectilinear opening 14a at a first end thereof. The link arm 14 may also have a contact section 14b at a second end thereof, opposed to the first end.

With the finger 20c of the actuator slidingly inserted in opening 14a, the rotation of the lever 20 may set in motion the link arm 14.

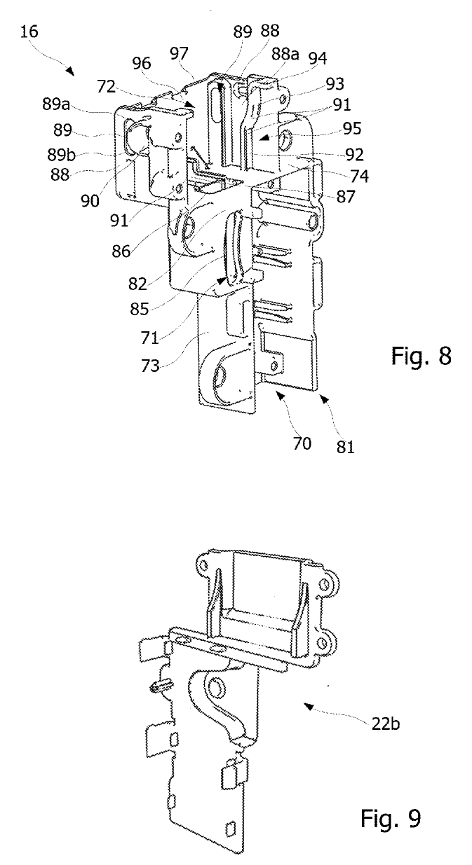

The bracket 16, shown individually in FIG. 8, is a frame part of the door handle system 8. In the assembled state of the door handle system 8, the bracket 16 is in particular accommodating the actuator 18, the link arm 14, and the swiveling member 12, and a guide for the link arm 14 and the swiveling member 12. The bracket 16 herein comprises a main body 22a, and a cover 22b (FIG. 9). The bracket 16 herein further comprises a first chamber 70, a second chamber 71, and a third chamber 72. According to an example, each of the chambers 70, 71 and 72 has a substantially parallelepiped shape.

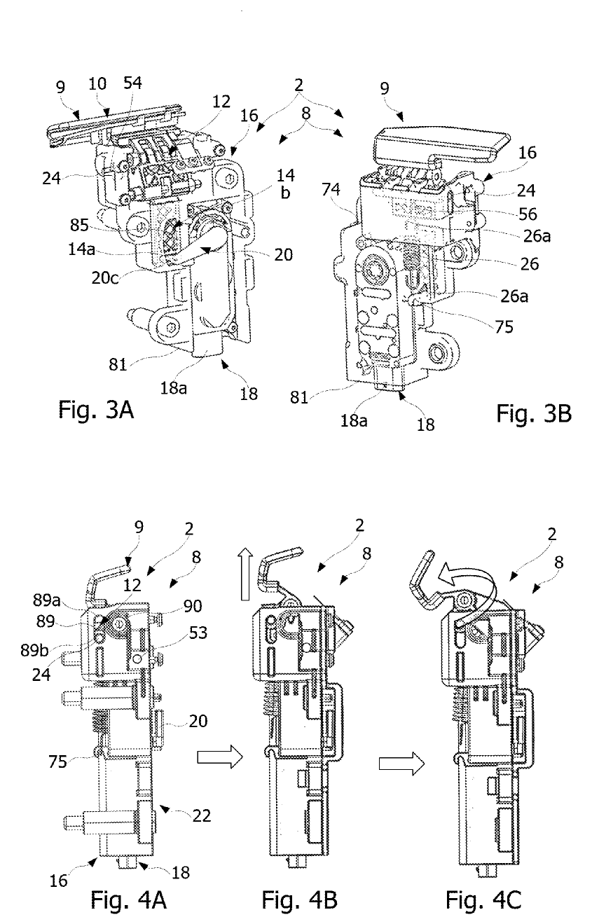

In the illustrated embodiment, a first separation wall 73 in the bracket 16 separates the first chamber 70 from the second chamber 71, and a second separation wall 74 separates the third chamber 72 from both the first chamber 70 and the second chamber 71. The first chamber 70 is intended to house the actuator 18. The first chamber 70 may be opened on a first side 80 of the bracket 16 to allow an easy insertion of actuator 18 into first chamber 70 upon assembling the door handle system 8. The first chamber 70 may also be opened on a second side 81 of the bracket 16, herein adjacent the first side 80. This allows for the connectors 18a of the actuator 18 and the cables (not shown) connected to the actuator 18 to pass through the external wall 74 of the first chamber 70 to the outside of bracket 16 (see FIGS. 3A and 3B).

The second chamber 71 is intended to house the link arm 14. The second chamber 71 therefore preferably has a flat elongated shape such as in the illustrated embodiment. An opening 85 is herein provided through an outer wall 82, on the first side 80 of the bracket 16. In the represented embodiment, this opening 85 may be arcuate. The opening 85 is preferably located adjacent the first chamber 70, and, in particular, adjacent the opened first side 80. This opening 85 allows for the actuator finger 20c to penetrate into the second chamber 71 and into the elongated opening 14a of the link arm 14, and thereby for the actuator 18 to set the link arm 14 in motion. The second chamber 71 opens out into the third chamber 72 through a first opening 86 provided in the second separation wall 74. Opening 86 allows for the link arm 14 to slide in and out of the second chamber 72, as explained later. The second chamber 71 also opens out to the outside of the bracket 16 through a second opening 87 provided in the second separation wall 74.

The third chamber 72 is intended to house the swiveling member 12. The third chamber 72 is delimited by two opposed walls 88, and a connection wall 96. Each wall 88 is transversal, preferably perpendicular, to both the second separation wall 74 and the connection wall 96. The connection wall 96 is provided with a free edge 97, opposed to the second separation wall 74.

According to an example, each of the walls 88 is provided with an oblong opening 89. Preferably, the oblong openings 89 may extend parallel to the connection wall 96. Each opening 89 extends between a first end 89a and a second end 89b. As will be explained later, the openings 89 are intended to accommodate the pivot members 24. The first end 89a forms a first abutment position for the pivot members 24. The second end 89b may form a second abutment position. One of the walls 88 is provided with a further opening 90 so as to allow the assembling member 47 to be inserted into the bracket 16 upon assembling the wing handle 9 and the swiveling member 12. Each of the walls 88 may further be provided with ribs 91 on the surface 88a of the walls 88 facing the third chamber 72 (FIG. 8).

The ribs 91 may define together guiding members for fingers 53. On each wall 88, the ribs 91 may include a pair of straight ribs 92, and preferably also a curved rib 93 as illustrated in FIG. 8. The straight ribs 92 of a same wall 88 extend parallel to one another, whereby they form a straight guiding section for the fingers 53. The curved rib 93 extends from the respective wall 88 at a constant distance with respect to the first end 89a of the respective opening 89. The curved rib 93 thereby offers a cam surface along which a respective finger 53 is movable. An abutment 94 is formed at an end of the curved rib 93. On each wall 88, the straight rib 92 closest to the opening 89 may extends continuous to the curved rib 93.

The bracket 16 may comprise a hook 75, serving as a lower fixed point for mounting the elastic member 26. In the illustrated embodiment, the hook 75 is protruding from an outer wall 76 of the bracket 16. More particularly, the hook 75 may be formed on the outer wall 76 at the back of the second chamber 71 (FIG. 5).

The elastic member 26 may be a return spring such as the helical spring shown in FIG. 2. Preferably, the elastic member 26 comprises a hook 26a at each respective end.

The arrangement of the different components of the door handle system 8 in the assembled state will be described hereinafter with reference to the embodiment illustrated in FIGS. 3A and 3B. In the vehicle 1, the bracket 16 may be fixedly mounted in position with respect to the window lower belt 6. A role of the bracket 16 is to define the positions and displacement paths of the actuator 18, the link arm 14 and the swiveling member 12 in order for the wing handle 9 to be displaced on demand from the stowed position to the deployed position, defined later, and backwards. Any movement of the mobile parts with respect to the bracket 16 is therefore an analogous movement with respect to the window lower belt 6.

In particular, the actuator 18 may be housed in the first chamber 70. The lever 20 protrudes out of the first chamber 70 so that finger 20c penetrates both into the second chamber 71 via the opening 85, and into opening 14a.

The cover 22b is applied against the main body 22a so as to close the first chamber 70, preferably at least on the first side 80. The cover 22b thereby protects the actuator 18 from any possible external interference.

In the assembled state, the link arm 14 is slidingly housed in the second chamber 71 so as to protrude through opening 86. The link arm 14 is longitudinally movable within the second chamber 71. The biasing member 26 extends through opening 87. One of the end hooks 26a of the biasing member 26 is attached to the eyelet 56 of the swiveling member 12, see FIGS. 2 and 3B. The opposite end hook 26a is attached to a fixed lower point of the bracket 16. In the illustrated embodiment, the fixed lower point is the hook 75 (FIG. 5). Under the effect of the biasing member 26, the swiveling member 12 is pulled towards the hook 75. As a consequence, the swiveling member 12 is constantly pulled towards the link arm 14 between a stowed position and a deployed position of the wing handle 9, described hereinafter. The contact section 14b therefore stays in permanent contact with the contact surface 62 over the deployment course of the wing handle 9, whereby the actuator 18 is able to exert thrust onto the swiveling member 12 via the link arm 14.

In the assembled state, and the swiveling member 12 is housed in the third chamber 72. The pivot members 24 are each engaged in a respective opening 89. Each pivot members 24 is slidingly movable within the respective opening 89. Each pivot member 24 can translate longitudinally within the opening 89 between the two ends 89a and 89b. In other words, the openings 89 are translation guides for the pivot members 24. In addition, the fingers 53 are slidingly engaged with the ribs 91, i.e., with the straight ribs 92 and the curved rib 93 acting as guides for the movement of the fingers 53.

The strain gauge 30 is arranged facing the contact surface 63, on a fixed point relative to the bracket 16. In the illustrated embodiment, the strain gauge 30 may be mounted on the cover 22b as shown in FIG. 5.

The door handle system 8 is operable from a stowed position illustrated in FIGS. 3A, 3B and 4A to a deployed position illustrated in FIGS. 4C and 5, via a transitory intermediate position illustrated in FIG. 4B. The interactions between the components over the transition from the stowed position to the deployed position will be detailed hereinafter.

In the stowed position, illustrated on FIGS. 3A and 3B, the lever arm 20 is retracted such that the link arm 14 is withdrawn in the second chamber 20. Under the effect of the biasing member 26, the swiveling member 12 is retained in the third chamber 72 such that the wing handle 9 is retracted. On the vehicle door 2, in the stowed position, the outer surface 10 of the wing handle 9 is flush with an outer surface 7 of the adjacent window lower belt 6. More precisely, the outer surface 7 and the outer surface 10 are aligned with each other towards a front of the vehicle 1. In other words, in the stowed position, the wing handle 9 is comprised within a geometrical envelope defined by the outer profile of the adjacent window lower belt 6.

Upon reception of a trigger signal from the vehicle electronics, a deployment stroke of the wing handle 9 from the stowed position to the deployed position is initiated by the actuator 18.

Starting from the stowed position, the actuator 18 first rotates lever 20. Rotating lever 20 translates the link arm 14 towards the swiveling member 12, whereby the finger 20c slides within opening 14a. Because the contact section 14b is in contact with the contact surface 62, the translation movement of the link arm 14 within the second chamber 71 pushes the swiveling member 12 away from the second separation wall 74. The pivot members 24 thereby slide within openings 89 and the fingers 53 slide between the straight ribs 92. The swiveling member 12 and the wing handle 9 thus follow together a linear movement: the translation sub-stroke. The translation sub-stroke lasts until the pivot members 24 reach the first abutment position 89a. At that point, the translation of the pivot members 24 stops. The swiveling member 12 and the wing handle 9 have reached a transitory intermediate position, illustrated in FIG. 4B. The transitory intermediate position is herein solely mentioned for a sound understanding of the transition between the translation sub-stroke and the subsequent rotation sub-stroke. Indeed, although this would be possible and not excluded by the present description, it is not intended that the door handle system 8 stops deploying between the two sub-strokes or undergoes a break at that moment.

As the lever 20 keeps rotating, the link arm 14 keeps extending into the third chamber 72, and the contact section 14a keeps pushing onto the contact surface 62. The swiveling member 12 and the wing handle 9 then undergo the rotation sub-stroke. Over the rotation sub-stroke, the swiveling member 12, together with the wing handle 9, rotates around axis X2 of pivot members 24 such that the fingers 53 rotate around the curved ribs 93. Upon the actuator 18 reaching a predefined halting position, the lever 20 stops rotating, the link arm 14 stops translating along the second chamber 71, and the swiveling member 12 and the wing handle 9 stop rotating around pivot members 24. Abutments 94 support the load and help preventing the fingers 53 from pivoting too far around the pivot members 24. At that point, the wing handle 9 is in the deployed position (FIG. 4C).

In the deployed position, the wing handle 9 is for example arranged in protrusion outwardly with respect to the window lower belt 6. The wing handle 9 is then accessible to a user, and may be manually operated to open the vehicle 1.

In order to open the vehicle 1, the user has to pull onto the wing handle 9. Upon pulling the wing handle 9, the user applies an outward force onto the grabbing portion 40. The wing handle 9 and the swiveling member 12 pivot outwardly around pivot members 24. Thereby, the swiveling member 12 elastically deforms so as to bring the contact surface 63 into contact with the strain gauge 30. Upon contacting the strain gauge 30, the contact surface 63 deforms the strain gauge 30. The strain gauge 30 is then configured to send a door unlocking signal to an ECU (Electronic Control Unit, not illustrated) of the vehicle 1, whereby the door unlocks. In the illustrated embodiment, the abutment sections 64 are provided as stops against an excessive operation of the wing handle 9. Indeed, the contact between the abutment sections 64 and the free edge 97 forming a secondary stop prevents the swiveling member 12 and the wing handle 9 from pivoting too far around the fingers 53 and thereby damaging the strain gauge 30.

Once the need to operate disappears, e.g., when the user starts the vehicle 1, or if the electronics in the vehicle 1 detects that the door is closed and that the user moved away from the vehicle 1, the door handle system 8 may undergo a retraction to bring the wing handle 9 back into the stowed position. In the illustrated embodiment, the movement of the wing handle 9 between the stowed position and the deployed position comprises a retraction of the wing handle 9 from the deployed position to the stowed position. For example, the retraction may comprise the rotation of the wing handle 9 followed by the translation of the wing handle 9. Over such a retraction, the lever 20 may be moved back into the starting position thereof together with the link arm 14, and/or the biasing member 26 may pull back the swiveling member 12. The retraction stroke may therefore operate in a reverse order with respect to the deployment stroke. The retraction from the deployed position illustrated in FIG. 4C to the stowed position of FIG. 4A may include reaching the transitory intermediate position of FIG. 4B.

According to an embodiment, the vehicle 1 may comprise a second vehicle door 2a adjacent vehicle door 2. The adjacent vehicle door 2a may comprise a door panel 4a (FIG. 1), a window 5a, and/or a window lower belt 6a. The adjacent vehicle door 2a may also comprise another door handle system 8a with a wing handle 9a. In the stowed position, the outer surface 10 of the wing handle 9 of vehicle door 2 may be configured to be flush with an outer surface 10a of the wing handle 9a and/or with an outer surface 7a of the window lower belt 6a (FIG. 1).

According to an embodiment, the adjacent vehicle door 2a in the vehicle 1 has a recess 11a (FIG. 1). The recess 11a may be formed in the exterior outline of the door panel 4a so that in the stowed position of the wing handle 9a, the wing handle 9a is housed within recess 4a.

The above description of various embodiments is provided for purpose of description to one of ordinary skills in the related art. It is not intended to be exhaustive or to limit the scope of the present disclosure solely to the disclosed embodiments. Numerous alternatives or variations to the present disclosure will be apparent to those of ordinary skills in the related art. Accordingly, while some alternatives or embodiments have been presented specifically, other embodiments will be apparent or easily developed by those of ordinary skills in the related art. Limitations in the appended claims should be interpreted broadly based on the language used in the claims and such limitations should not be restricted to the specific examples described above.

Unless otherwise expressly indicated herein, all numerical values indicating mechanical/thermal properties, compositional percentages, dimensions and/or tolerances, or other characteristics are to be understood as modified by the word “about” or "approximately" in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A door handle system for a vehicle, comprising a wing handle, wherein the wing handle is movable between a stowed position and a deployed position,
wherein:
in the stowed position, an outer surface of the wing handle is configured to be flush with an outer surface of an adjacent window lower belt;
in the deployed position, the wing handle is configured to be protruding outwardly with respect to said outer surface of the adjacent window lower belt;
wherein the door handle system comprises an actuator configured to move the wing handle between the stowed position and the deployed position; and
wherein a movement of the wing handle between the stowed position and the deployed position comprises a translation from and/or to the stowed position.

2. The door handle system according to claim 1, wherein the movement of the wing handle between the stowed position and the deployed position comprises a rotation in which the wing handle is pivoted outwardly towards the deployed position and/or inwardly towards the stowed position.

3. The door handle system according to claim 2, wherein the movement of the wing handle between the stowed position and the deployed position comprises the translation of the wing handle, followed or preceded by the rotation of the wing handle.

4. The door handle system according to claim 3, wherein the movement of the wing handle between the stowed position and the deployed position comprises a deployment of the wing handle from the stowed position to the deployed position, the deployment comprising the translation of the wing handle followed by the rotation of the wing handle.

5. The door handle system according to claim 3, wherein the movement of the wing handle between the stowed position and the deployed position comprises a retraction of the wing handle from the deployed position to the stowed position, the retraction comprising the rotation of the wing handle followed by the translation of the wing handle.

6. The door handle system according to claim 1, further comprising a swiveling member, wherein the wing handle is integrally mounted on the swiveling member,
wherein the actuator is configured to cause the swiveling member to translate so as to cause the translation of the wing handle from and/or to the stowed position, and
wherein the actuator is configured to cause the swiveling member to pivot so as to cause a rotation of the wing handle outwardly towards the deployed position and/or inwardly towards the stowed position.

7. The door handle system according to claim 6, further comprising a bracket configured to be fixedly mounted in position with respect to the adjacent window lower belt, wherein the swiveling member comprises at least one pivot member, the at least one pivot member defining a first axis, wherein the swiveling member is mounted to the bracket via said at least one pivot member, and wherein the swiveling member is configured to move in rotation with respect to the bracket around the first axis when the actuator causes the swiveling member to pivot so as to cause the rotation of the wing handle outwardly to the deployed position.

8. The door handle system according to claim 7, wherein the swiveling member further comprises at least one first guiding member, and the bracket comprises at least one second guiding member, wherein the at least one first guiding member and the at least one second guiding member are configured to slidingly cooperate with each other in guiding the swiveling member when the actuator causes the swiveling member to pivot.

9. The door handle system according to claim 8, wherein the at least one first guiding member is a finger, wherein the finger extends along a second axis parallel to the first axis along which the at least one pivot member is extending, wherein the at least one second guiding member is a curved guiding rib, wherein the finger and the curved guiding rib are configured so that the finger is traveling along the curved guiding rib when the swiveling member is moving in rotation around the at least one pivot member over the rotation.

10. The door handle system according to claim 9, wherein:
the bracket has at least one oblong opening, wherein the at least one pivot member is both slidingly and pivotingly mounted in the at least one oblong opening,
over the translation, the swiveling member is moved in translation with respect to the bracket by the at least one pivot member translating in the at least one oblong opening until a first end of the at least one oblong opening, whereby the first end of the at least one oblong opening forms an abutment position for the at least one pivot member, and
over the rotation, the swiveling member is movable in rotation with respect to the bracket around the at least one pivot member in the abutment position of the at least one pivot member at the first end of the at least one oblong opening.

11. The door handle system according to claim 10, wherein the bracket comprises at least one straight guiding rib, wherein, over the translation, the finger is moved in translation with respect to the at least one straight guiding rib concurrently to the at least one pivot member being moved in translation in the at least one oblong opening until the first end of the at least one oblong opening, the curved guiding rib extending from the at least one straight guiding rib.

12. The door handle system according to claim 7, further comprising a link arm slidingly mounted in the bracket, wherein the actuator is configured to cause the link arm to move in translation with respect to the bracket so as to interact with the swiveling member so as to exert a pushing force to the swiveling member so as to move to the wing handle towards the deployed position.

13. A vehicle door comprising a door handle system according to claim 1, wherein the vehicle door comprises the adjacent window lower belt, and wherein:
in the stowed position, the outer surface of the wing handle is configured to be flush with the outer surface of the adjacent window lower belt; and
in the deployed position, the wing handle is configured to be protruding outwardly with respect to the outer surface of the adjacent window lower belt.

14. A vehicle comprising one or more vehicle door handle systems according to claim 1, and a window lower belt, wherein:
in the stowed position, the outer surface of the wing handle is configured to be flush with the outer surface of the window lower belt;
in the deployed position, the wing handle is configured to be protruding outwardly with respect to the outer surface of the window lower belt.
